(19) United States
(12) Patent Application Publication
(10) Pub. No.: US 2011/0110378 A1
(43) Pub. Date: May 12, 2011

(54) Method and Apparatus for Communications Traffic Breakout

(75) Inventors: Teemu Savolainen, Nokia (FI); Seppo Ilmari Vesterinen, Oulunsalo (FI); Matti Einari Laitila, Oulu (FI)

(73) Assignee: Nokia Corporation

(21) Appl. No.: 12/615,571

(22) Filed: Nov. 10, 2009

(51) Int. Cl. H04L 12/56; H04J 3/24

(52) U.S. Cl. 370/400; 370/474

(57) ABSTRACT

Various methods for communications traffic breakout are provided. One example method comprises generating packets for transmission from a first source of a client device via a bearer service between the client device and a server, and generating packets for transmission from a second source of the client device via the bearer service. The example method also includes directing transmission of packets from the first and second sources via the bearer service to a middlebox. The middlebox may be configured to forward packets from the first source to the server via the bearer service, and breakout, from the bearer service, packets from the second source and route the packets from the second source to a separate network. Similar and related example methods and example apparatuses are also provided.

### TECHNICAL FIELD

Embodiments of the present invention relate generally to mobile communications, and, more particularly, relate to a method and apparatus for communications traffic breakout.

### BACKGROUND

The modern communications era has brought about a tremendous expansion of wireline and wireless networks. Various types of networking technologies have been developed resulting in unprecedented expansion of computer networks, television networks, telephony networks, and the like, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. The functionality of mobile communications devices continues to expand and, as a result, mobile communications devices have become ubiquitous in both business and personal settings. As the functionally of mobile communications devices and the ease of information transfer continues to increase, users continue to demand more functionality that allows the users to quickly find and interact with more data in unique ways.

Some users expect mobile communication devices to be as powerful as conventional computing systems and offer the same types and levels of network connectivity in a wireless package. Many users desire streamlined connections with both local area networks (LANs) and other networks, such as the Internet, that are available via through a communications core network for mobile communications.

### BRIEF SUMMARY

Various example methods and apparatuses of the present invention are described herein for routing packets, received via a bearer service, to a server, such as server connected to a core network, or breaking out packets from the bearer service and routing packets to a separate network, such as a LAN. One example method comprises generating packets for transmission from a first source of a client device via a bearer service between the client device and a server and generating packets for transmission from a second source of the client device via the bearer service. The example method also includes directing transmission of packets from the first and second sources via the bearer service to a middlebox. The middlebox may be configured to forward packets from the first source to the server via the bearer service, and breakout, from the bearer service, packets from the second source and route the packets from the second source to a separate network.

A related example apparatus for communications traffic breakout comprises at least one processor and at least one memory including computer program code, the at least one memory and the computer program code configured to, with the at least one processor, cause the apparatus at least to perform various functionalities. In this regard, the example apparatus is caused to perform generating packets for transmission from a first source of a client device via a bearer service between the client device and a server, and generating packets for transmission from a second source of the client device via the bearer service. The example apparatus is also caused to perform directing transmission of packets from the first and second sources via the bearer service to a middlebox. The middlebox may be configured to forward packets from the first source to the server via the bearer service, and breakout, from the bearer service, packets from the second source and route the packets from the second source to a separate network.

One example embodiment is an example computer-readable storage medium having executable computer-readable program code instructions stored therein. The computer-readable program code instructions of the example computer-readable storage medium are for causing an apparatus to perform various functionalities. In this regard, the example apparatus is caused to perform generating packets for transmission from a first source of a client device via a bearer service between the client device and a server, and generating packets for transmission from a second source of the client device via the bearer service. The example apparatus is also caused to perform directing transmission of packets from the first and second sources via the bearer service to a middlebox. The middlebox may be configured to forward packets from the first source to the server via the bearer service, and breakout, from the bearer service, packets from the second source and route the packets from the second source to a separate network.

Another example embodiment is an example apparatus for communications traffic breakout. The example apparatus comprises means for generating packets for transmission from a first source of a client device via a bearer service between the client device and a server, and means for generating packets for transmission from a second source of the client device via the bearer service. The example apparatus also includes means for directing transmission of packets from the first and second sources via the bearer service to a middlebox. The middlebox may be configured to forward packets from the first source to the server via the bearer service, and breakout, from the bearer service, packets from the second source and route the packets from the second source to a separate network.

Another example embodiment of the present invention is an example method for communications traffic breakout. The example method includes receiving packets via a bearer service between the client device and a server, the packets including packets from a first source of a client device and a second source of the client device. The example method also includes analyzing the packets received via the bearer service to distinguish packets from the first source from packets from the second source. Further, the example method includes forwarding packets from the first source to the server via the bearer service, and breaking out, from the bearer service, packets from the second source and routing the packets from the second source to a separate network.

A related example apparatus for communications traffic breakout comprises at least one processor and at least one memory including computer program code, the at least one memory and the computer program code configured to, with the at least one processor, cause the apparatus at least to perform various functionalities. In this regard, the example apparatus is caused to perform receiving packets via a bearer service between the client device and a server, the packets including packets from a first source of a client device and a second source of the client device. The example apparatus is also caused to perform analyzing the packets received via the bearer service to distinguish packets from the first source from packets from the second source. Further, the example apparatus is caused to perform forwarding packets from the first source to the server via the bearer service, and breaking out, from the bearer service, packets from the second source and routing the packets from the second source to a separate network.

Another example embodiment is an example computer-readable storage medium having executable computer-readable program code instructions stored therein. The computer-readable program code instructions of the example computer-readable storage medium are for causing an apparatus to perform various functionalities. In this regard, the example apparatus is caused to perform receiving packets via a bearer service between the client device and a server, the packets including packets from a first source of a client device and a second source of the client device. The example apparatus is also caused to perform analyzing the packets received via the bearer service to distinguish packets from the first source from packets from the second source. Further, the example apparatus is caused to perform forwarding packets from the first source to the server via the bearer service, and breaking out, from the bearer service, packets from the second source and routing the packets from the second source to a separate network.

Another example embodiment is an example apparatus for communications traffic breakout. The example apparatus comprises means for receiving packets via a bearer service between the client device and a server, the packets including packets from a first source of a client device and a second source of the client device. The example apparatus also includes means for analyzing the packets received via the bearer service to distinguish packets from the first source from packets from the second source, means for forwarding packets from the first source to the server via the bearer service, and means for breaking out, from the bearer service, packets from the second source and routing the packets from the second source to a separate network.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a system for communications traffic breakout according to an example embodiment of the present invention;

FIG. 2 illustrates an example internet protocol stack according to an example embodiment of the present invention;

FIG. 3 illustrates another system for communications traffic breakout according to an example embodiment of the present invention;

FIG. 4 illustrates yet another system for communications traffic breakout including a laptop personal computer and a separate terminal/modem according to an example embodiment of the present invention;

FIG. 5 illustrates a block diagram of an apparatus for communications traffic breakout according to an example embodiment of the present invention;

FIG. 6 illustrates a block diagram of a mobile terminal for communications traffic breakout according to an example embodiment of the present invention

FIG. 7 illustrates a flow chart of a method for communications traffic breakout according to an example embodiment of the present invention;

FIG. 8 illustrates a block diagram of another apparatus for communications traffic breakout according to an example embodiment of the present invention; and

FIG. 9 illustrates a flow chart of another method for communications traffic breakout according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Various example embodiments of the present invention support communications traffic breakout from a bearer service. According to various example embodiments, a bearer service may be a type of virtual point-to-point connection or transport service between two network entities or end points. For example, the bearer service may be a packet data protocol (PDP) context and/or a enhanced packet system (EPS) bearer. As such, the bearer service may support long-term evolution (LTE) based communications techniques. The end points of the bearer service may be a client device, such as, for example, user equipment (UE) in the form of a mobile terminal, and a server, such as, for example, a packet data network gateway (PDN-GW) and/or a general packet radio service (GPRS) gateway support node (GGSN). In some example embodiments, a bearer service is a transport service with specific and defined quality of service (QoS) attributes.

According to various example embodiments of the present invention, a client device may maintain a bearer service to a server that provides access to a core network of a wireless communications system. Having established the bearer service with the server, the client device may also wish to communicate, perhaps more locally, with a second, separate network, such as a local area network (LAN). To conduct communications with the second network, the client device may be configured to transmit packets intended for the second network through the bearer service to an intermediate middlebox. The middlebox may be configured to forward packets intended for the core network to the server, and break out and route packets intended for the second network to the second network. Since the packets intended for the second network may be intercepted by the middlebox, the server and the core network may be unaware of the packets intended for the second network. In this manner, simultaneous support for both core network communications and local area network communications may be achieved through multiple interfaces via a single bearer service. Example embodiments therefore support local IP access (LIPA), without visibility, or with limited visibility, to the core network.

To provide for breaking out packets intended for the second network from the bearer service, the client device may establish separate sources for the packets intended for the server, and the packets intended for the second network, respectively. In other words, a first source may be established for communications to the server and the core network, and a second source may be established for communications to the second network. In some example embodiments, the sources may be treated as separate communications interfaces within the client device. In this regard, applications executed on the client device may interact with the sources as physical interfaces, and behave accordingly, such as by performing source address selection.

The packets from each of the separate sources may acquire particular characteristics based on the type of source. A source may be defined, for example, by a distinct source address (e.g., source internet protocol (IP) address) and/or by a communications protocol that is used to generate packets from the particular source (e.g., point-to-point protocol (PPP), internet protocol, Ethernet, or the like). Although the client device may employ more than one source, the packets generated for each of the sources may be transmitted together via the bearer service. In this regard, according to some example embodiments, the packets from each of the sources may be multiplexed and transmitted using a common radio to the bearer service.

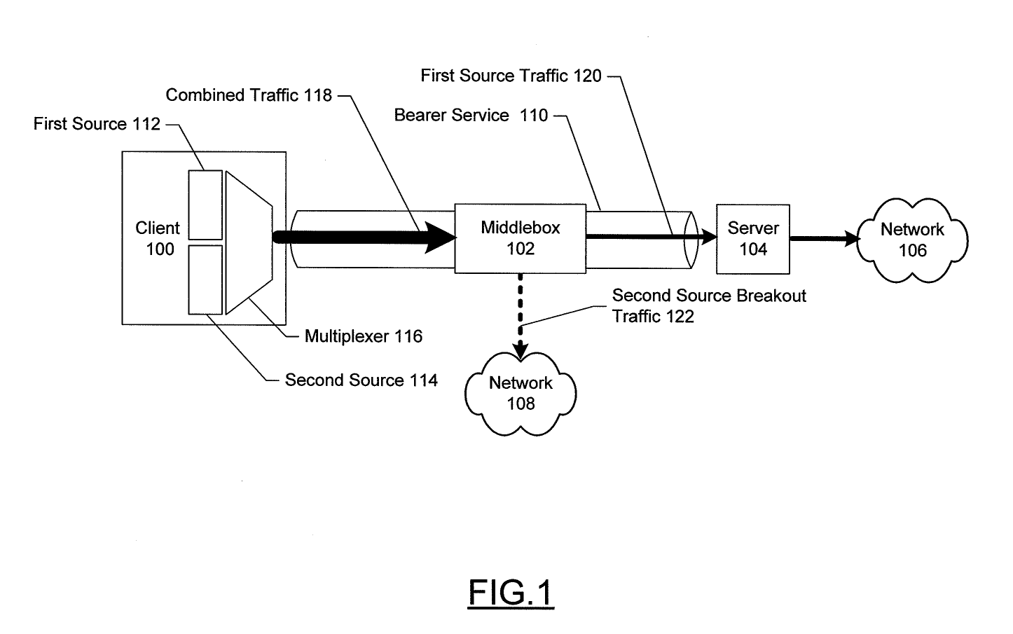

In light of the foregoing, FIG. 1 illustrates an example system for communications traffic breakout according to various example embodiments of the present invention. The system of FIG. 1 includes a client 100, a middlebox 102, a server 104, a network 106, and a network 108. The client 100 may be any type of wired or wireless communications device such as a mobile terminal, a laptop computer with a wireless modem, or other type of user equipment. The middlebox 102 may be a network communications entity, such as a base station configured as an enhanced node B (eNB) or a Home eNB. The middlebox 102 may provide connections to a server 104 and a network 108. The network 108 may be, for example, local to the middlebox 102 and/or the client 100, and the network 108 may be a wired or wireless LAN, which may be multicast enabled. The server 104 may be another network communications entity, such as a PDN-GW and/or a GGSN. The server 104 may provide a connection to a network 106, which may be the core network. According to some example embodiments, the network 106 may include or connect to the Internet.

A bearer service 110 may also be established between the client 100 and the server 104. According to some example embodiments, the bearer service 110 may support a point-to-point connection, and be configured as, for example, a PDP context and/or an EPS bearer. The bearer service 110 may pass through the middlebox 102, and the middlebox 102 may be configured to facilitate maintaining the bearer service 110 between the client 100 and the server 104.

In general, the client 100 may be configured to establish at least two sources (e.g., first source 112 and second source 114) for providing communications traffic via the bearer service 110. Data packets from each of the first source 112 and the second source 114 may be generated having characteristics based on the type of source. According to some example embodiments, the data packets from the sources may be multiplexed by the multiplexer 116 and provided to the bearer service 110 as combined traffic 118. The combined traffic 118 from the client 100 may be received or intercepted by the middlebox 102, and the middlebox 102 may be configured to analyze the packets to determine whether the packets originated from the first source 112 or the second source 114. Packets from the first source may be passed or forwarded to the server 104 as first source traffic 120. Packets from the second source may be broken out of the bearer service 110 and routed as second source breakout traffic 122 to the network 108.

While the example embodiments described herein address situations involving one source (e.g., the second source 114) to support packet breakout from the bearer service, any number of sources may be configured for packet breakout. In this regard, a client device (e.g., during radio access signaling or via some other means such as dynamic host configuration protocol signaling) may establish, or be requested to establish, a number of sources and associated interfaces. In this regard, a point-to-point connection via the bearer service 110 to the “Internet” or “Operator intranet” may be established, and sources configured for packet breakout may be configured for the same or different destinations, such as the “Internet”, “Corporate Intranet” or “Home network.”

According to various example embodiments, packets for the first and second source may be generated in a number of ways. According to some example embodiments, as further described below, a first IP address associated with a first source 112 may be established for the client 100 for use with a point-to-point connection supported by the bearer service 110, and a second, and possibly local, IP address associated with the second source 114 may be established. The second IP address may also be used with the bearer service 110, and the second IP address may be known to the middlebox 102. As such, the middlebox 102 may breakout and route packets having the second IP address to, for example a local network (e.g., network 108).

According to some example embodiments, the second IP address may be determined and utilized in a manner that may not be detected by the server 104, due to the middlebox 102 intercepting and routing the traffic associated with the second IP address to the network 108. To establish the second IP address, client 100 may be notified by the middlebox 102 about possibility for configuration of a second IP address for the bearer service 110. The client 100 may communicate with the middlebox 102 and configure the second IP address and a point-to-point connection. In some example embodiments, the client 100 may select the address unilaterally, while in other example embodiments the middlebox 102 may be employed to assist in the selection of a second address. The middlebox 102 may thereafter be configured to inspect the traffic of the bearer service 110, and make forwarding and routing decisions based on addresses (e.g., the source and/or destination addresses) of the packets transmitted from the client 100.

In accordance with another example embodiment, the client 100 may be configured to generate different protocol type packets for the respective sources. For example, packets for the first source may be formatted in accordance with a first protocol (e.g., IP) and packets for the second source may be formatted in accordance with a second protocol (e.g., Ethernet). Alternatively, in some example embodiments, packets for the second source 114 may be generated in a first protocol, and subsequently encapsulated in a second protocol (e.g., Ethernet over IP). Regardless of the specific characteristics of the packets, the middlebox 102 may be configured to distinguish packets for the first source 112 from packets for the second source 114, and route the packets accordingly (e.g., break out packets form the second source 114).

With respect to routing the communications traffic of the bearer service 110, the middlebox 102 may be configured to pass traffic from the first source 112 in the direction of the server 104 and the network 106 (e.g., the core network) as first source traffic 120. However, the middlebox 102 may also be configured to analyze characteristics of the packets (e.g., the source addresses of the packets, the protocols of the packets, whether an encapsulation of protocols is present, or the like) transmitted from the client 100, and breakout packets from the bearer service 110 based on the analysis. The packets that are broken out of the bearer service 110 may be directed to other destinations, such as network 108, which may be a home network or the Internet.

The following provides additional details of various example embodiments of the present invention. In particular, example embodiments are described for implementing a second address scheme in an internet protocol version 4 (IPv4) setting and in an internet protocol version 6 (IPv6) setting. Further, an example embodiment is described that utilizes an IP over Ethernet tunnel and encapsulation associated with a second source, and yet another example embodiment is described that involves transmission of Ethernet packets directly in the bearer service 110 with IP packets.

With respect to an example IPv4 addressing scheme, the middlebox 102 may be configured to inform to the client 100 (e.g., in Radio Access Signaling (RAS)) about the possibility of obtaining a second, and possibly local, IP address for a point-to-point connection of the bearer service 110. According to some example embodiments, the second IP address may be used as a source IP address when generating packets from the second source 114 and intended for breakout to the network 108. In response to the notification, the client 100 may send a response communication indicating that the client 100 desires the second IP address. According to some example embodiments, the response communication may be a DHCPDISCOVER-message on the bearer service 110 with a destination IPv4 address set to, for example, 255.255.255.255. In this regard, the DHCPDISCOVER-message may be prepared and formatted in accordance with section 4.4.1 of the Dynamic Host Configuration Protocol (DHCP) standard located at http://www.ietf.org/rfc/rfc2131.txt, which is hereby incorporated by reference in its entirety. The middlebox 102 may be configured to intercept the response communication and either forward the response communication to an external server (e.g., a DHCP server), or reply to the response communication, for example in the form of a DHCPOFFER-message, with a second IP address (e.g., an IPv4 address) allocated to the client 100. Alternatively, in some example embodiments, if the response communication is forwarded to a DHCP server, the middlebox 102 may present the client 100 for the local area network on layer 2, and defend the second address with address resolution protocol (ARP).

Upon obtaining a second IP address, the client 100 may be assigned two IP addresses for a point-to-point connection via the bearer service 110. The first IP address may be configured from the server 104, and the second IP address may be configured from or via the middlebox 102 and the middlebox 102 may be configured to store a record of at least the second IP address for use in analyzing future communications traffic. Since the middlebox 102 is aware of the second IP address, the middlebox 102 may be configured to receive packets from the client 100 via the bearer service 110 and perform packet forwarding and routing decisions based on source IP address used by the client 100 in the respective packets.

According to various example embodiments, the client 100 may treat the first source 112, associated with a first IP address, and the second source 114, associated with the second IP address, as separate physical (or virtual) network interfaces. The first source 112 may be the network interface associated with a point-to-point connection on the bearer service 110 to the server 104, and the second source 114, with the associated second IP address, may be treated as a second point-to-point connection on the bearer service 110 the network interface to the network 108, which may be presented as a network interface to a local area network.

According to another example embodiment, an alternative second address scheme may be implemented using IPv6 addressing. In this regard, the middlebox 102 may be configured to inform to the client 100 (e.g., in RAS) about the possibility of obtaining a second, and possibly local, IP address for a point-to-point connection on the bearer service 110. In response, the client 100 may be configured to send a response communication, for example, in the form of a router solicitation message to the bearer service 110. Replying to the response communication from the client 100, the middlebox 102 may be configured to inject or transmit a router advertisement message on the bearer service 110 to the client 100. When the client 100 receives a new router advertisement message, and if a Stateless Address Autoconfiguration procedure is used (as described in RFC4862, IPv6 Stateless Address Autoconfiguration at http://www.rfc-editor.org/rfc/rfc4862.txt which is hereby incorporated by reference in its entirety), the client 100 may configure a second address for a point-to-point connection on the bearer service 110 based on a prefix, after an interface identifier selection is performed. Accordingly, a Duplicate Address Detection (DAD) procedure may be performed for the newly configured second address to ensure the validity of the prefix and the address. As the client 100 sends DAD for the prefix, the middlebox 102 may be configured to inspect the prefix and not pass the associated packet or packets to the server 104, but route the packet or packets associated with the DAD to the network 108. Entities associated with the network 108 may be configured to ensure that no conflict with other entities of the network exist. In some example embodiments, due to the shared prefix, the middlebox 102 may be configured to store the addresses that are in use, to ensure proper packet routing and avoid conflicts. If Stateful Address Autoconfiguration is used, as described in RFC3315, Dynamic Host Configuration Protocol for IPv6 (DHCPv6) at http://www.ietf.org/rfc/rfc3315.txt which is incorporated by reference in its entirety, the client 100 may send a DHCP Solicit message to the All DHCP Relay Agents and Servers address (FF02::1:2) which maybe intercepted by the middlebox 102. The middlebox 102 may be configured to either reply to the DHCP Solicit message or forward the DHCP Solicit message to network 108. The obtained second address can be utilized for breakout purposes since the middlebox 102 can maintain a record of the addresses that are used by the client 100 or other clients. After configuration of the IPv6 second address based on the prefix is complete, the client 100 may utilize, for example, a single point-to-point connection interface via the bearer service 110 with multiple addresses associated with corresponding sources (e.g., the first source 112 and the second source 114) to applications, or two separate interfaces for the corresponding sources may be utilized with respect addresses.

According to some additional example embodiments, different protocols may be used for the packets associated with the first and the second source. In this regard, according to various example embodiments, Ethernet packets may be sent with IP packets directly on the bearer service 110, or Ethernet packets may be encapsulated within IP packets using an Ethernet over IP tunnel. As a result, the network 108 may be directly visible for the client 100. In this regard, ARP and neighbor discovery messages may be sent from the client 100 directly to the network 108 (e.g., the LAN).

In accordance with an example embodiment that involves encapsulation of packets of a first protocol (e.g., Ethernet packets) within packets of a second protocol (e.g., IP), the middlebox 102 may be first configured to inform the client 100 (e.g. via RAS) about the possibility of establishing an Ethernet connection with network 108. In response the client 100 may establish an Ethernet over IP tunnel (e.g., as per RFC3378, EtherIP: Tunneling Ethernet Frames in IP Datagrams located at http://www.ietf.org/rfc/rfc3378.txt which is hereby incorporated by reference in its entirety). The tunnel may be established within the bearer service 110 with respect to, for example, the second source 114. According to some example embodiments, the tunnel endpoint address (e.g., IPv4 address) may be set to predefined address, such as, for example, a multicast address (e.g., 255.255.255.255). The middlebox 102 may be configured to determine, based on the use of the predefined address, that the middlebox 102 is the intended endpoint for the tunnel. As the endpoint of the tunnel, the middlebox 102 may be configured to receive packets via the tunnel, break the packets out of the bearer service 110, and route the packets to the network 108. According to some example embodiments, the client 100 may be configured to use the address (e.g., IPv4 address) received from the server 104 as source IP address for the packets. According to various example embodiments, the encapsulation may be performed on a number of platforms including but not limited to, IPv4 address platforms, IPv6 address platforms, Layer 2 Tunneling Protocol version 3 (L2TPv3) platforms, and Ethernet over L2TPv3 platforms. The encapsulated packets may be associated with the second source 114, and the middlebox 102 may be configured to analyze the packets received from the client 100 via the bearer service 110 to identify the encapsulated packets and route the encapsulated packets, possibly after de-encapsulating the packets, to the network 108 as second source breakout traffic 112. According to various example embodiments, the client 100 may treat the second source 114 in this regard, as a standard Ethernet interface to the network 108.

In accordance with yet another example embodiment, packets for the first source 112 may be generated in accordance with a first protocol, and packets for the second source 114 may be generated in accordance with a second protocol. In accordance with one example embodiment, the first protocol is IP and the second protocol is Ethernet. In this regard, the middlebox 102 may be first configured to inform the client 100 (e.g. via RAS) about the possibility of establishing an Ethernet connection with network 108. In response, the client 100 may send Ethernet packets directly over the bearer service 110 (e.g., 3^{rd} Generation Partnership Project (3GPP) bearer), and the middlebox 102 may be configured to determine whether the packets sent by the client 100 are Ethernet or IP packets (or frames). If a packet is an IP packet, the packet may be forwarded to the server 104, but if the packet is an Ethernet packet, the packet may be broken out of the bearer service 110 and routed to the network 108, which may be a LAN.

According to various example embodiments, by sending the Ethernet packets directly on the bearer service, no IP tunneling is required and no maximum transmission unit (MTU) issues arise (e.g., 1500 byte MTU is available for the client 100). The client 100 may treat the first source 112 as a point-to-point protocol (PPP) interface to the server 104 and the second source as an Ethernet interface. In this regard, according to various example embodiments, the operating system of the client 100 may present two physical interfaces (e.g., two sources) for the IP stack, one for a PPP connection to the server 104, and another for an Ethernet interface to the network 108. The interfaces may be multiplexed, by the multiplexer 116, into the bearer service 110, which may reside on a lower layer.

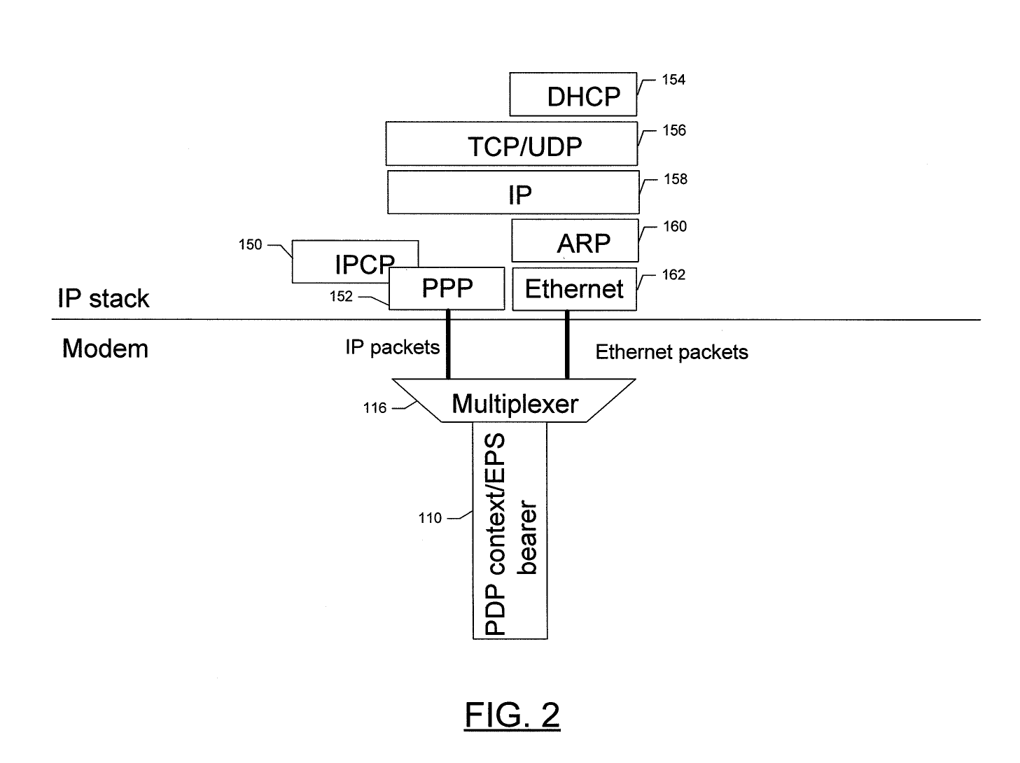

FIG. 2 illustrates an example IP stack with connections to a modem (e.g., a 3GPP modem). The PPP layer 152 may established on a internet protocol control protocol (IPCP) layer 150, which together may form a first source or first interface to support the transmission of IP packets to the multiplexer 116. According to some example embodiments, a transmission control protocol/user datagram protocol (TCP/UDP) layer may also be included above the PPP layer 152. The Ethernet layer 162 may be established on an ARP layer 160, an IP layer 158, a TCP/UDP layer 156, and a DHCP layer 154. The Ethernet layer 162, together with the layers upon which the Ethernet layer 162 is constructed, may form a second source or second interface to support transmission of Ethernet packets to the multiplexer 116. Via the multiplexer 116, the IP and Ethernet packets may be sent through the bearer service 110, which, as depicted in FIG. 1, may be a PDP context/EPS bearer.

According to various example embodiments, implementing the transmission the Ethernet packets on the bearer service provides the benefits of enabling future evolution towards Ethernet-type of EPS bearers, and, if the middlebox 102 fails to break Ethernet packets out from the bearer service, a server 104 embodied as a PDN-GW may silently discard the Ethernet packets, which may occur when the client 100 moves away from the coverage area of the middlebox 102 (e.g., Home eNB). Further, according to various example embodiments, the type of bearer service 110 need not affect the operation since IPv4, IPv6, or Dual-Stack bearers may be utilized. Further, according to some example embodiments, since the Ethernet packets are multiplexed into a common bearer service 110, the Ethernet packets are hidden from some or all network entities, other than the middlebox 102 (e.g., Home eNB) and the network 106 (e.g., the core network) may be only aware of the IP packets that are transmitted on a bearer service 110.

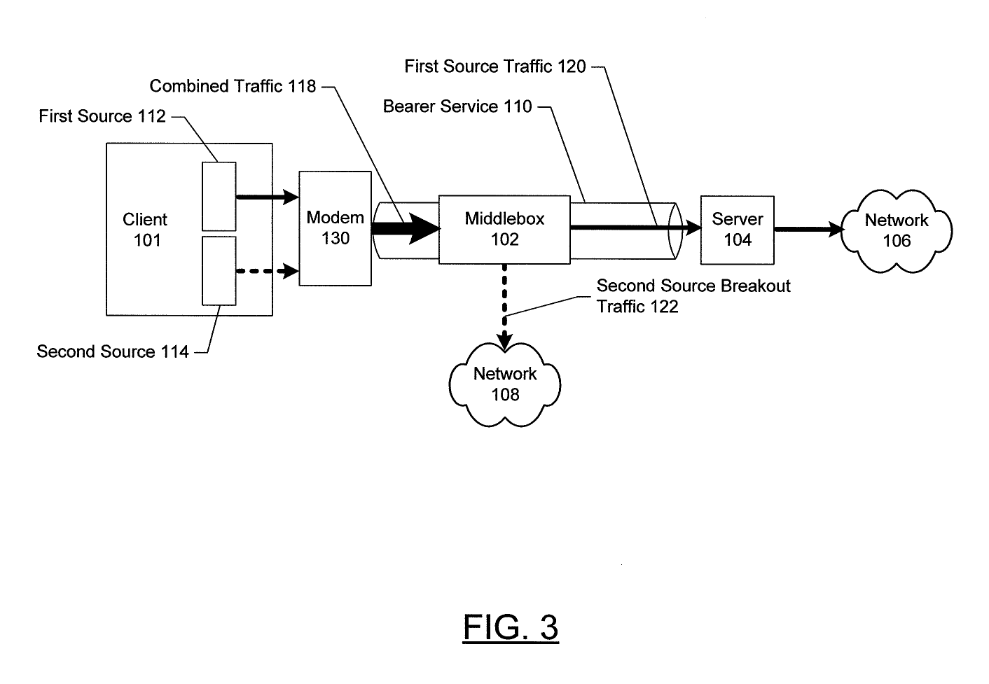

It is noteworthy that the client 100 of FIG. 1 may be configured such that a device driver of the client 100 may be configured to handle the establishment and maintenance of the first source 112 (e.g., first interface) and the second source 114 (e.g., second interface) and the subsequent multiplexing of the packets via the multiplexer 116. A modem may receive the multiplexed packets from the multiplexer 116 and transmit the packets without being specially configured to support the multi-source/multi-interface scheme. In this regard, the modem operates as if the multiple sources are a single source of packets. The example embodiment depicted with respect to FIG. 3, however, illustrates a client 101 that does not include a multiplexer and is connected to a modem 110 (which may be configured to perform multiplexing). The client 101 may otherwise operate and be configured similar to client 100. According to some example embodiments, client 101 may be a laptop personal computer (PC) and the modem 130 may be an external wireless modem. In this configuration, the modem 130 may be specifically configured to support combination of the packets from the first source 112 and the second source 114 and provide the combined traffic 118 to the bearer service 118. For example, the modem 130 may be configured to perform Ethernet over IP encapsulation to facilitate packet breakout by the middlebox 102. The client 101 may treat the first source 112 as a connection to a physical network device (e.g., a universal serial bus (USB) connection) for a PPP connection, and treat the second source 114 as another physical network device connection for an Ethernet connection.

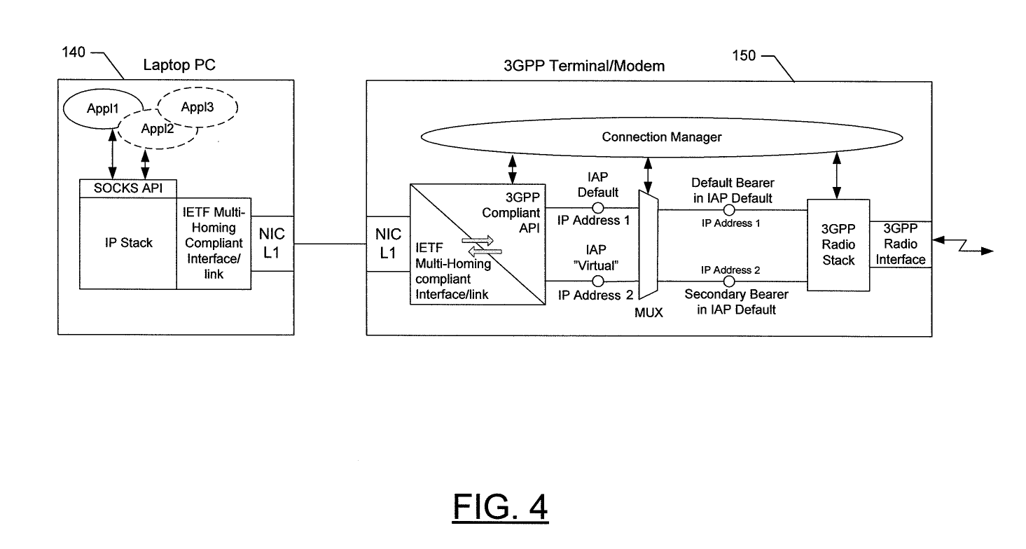

In this regard, FIG. 4 depicts a more detailed block diagram of the interaction between an example laptop PC 140 and a separate 3GPP terminal/modem 150. In accordance with example embodiment depicted with respect to FIG. 4, the terminal/modem is specifically configured to support multiple source IP addresses for use with a bearer service. In accordance with the example embodiment depicted in FIG. 4, a multihoming compliant link may be established between the laptop PC 140 and the terminal/modem 150. The terminal/modem 150 may provide connectivity to an associated access point name using a primary bearer and a secondary dedicated bearer with different IP addresses. As indicated by the features of the laptop PC 140, applications being executed by the laptop PC 140 may interact with the IP stack to ultimately interface with the terminal/modem 150 for communications purposes. The terminal/modem 150 may be configured to establish an IP address 1 and an IP address 2. Packets generated with respect to each of the IP addresses may be multiplexed and transmitted via a common radio interface to a bearer service. The connection manager may be configured to manage compliance, multiplexing of the packets, and interactions with the radio stack to achieve the desired performance as described above.

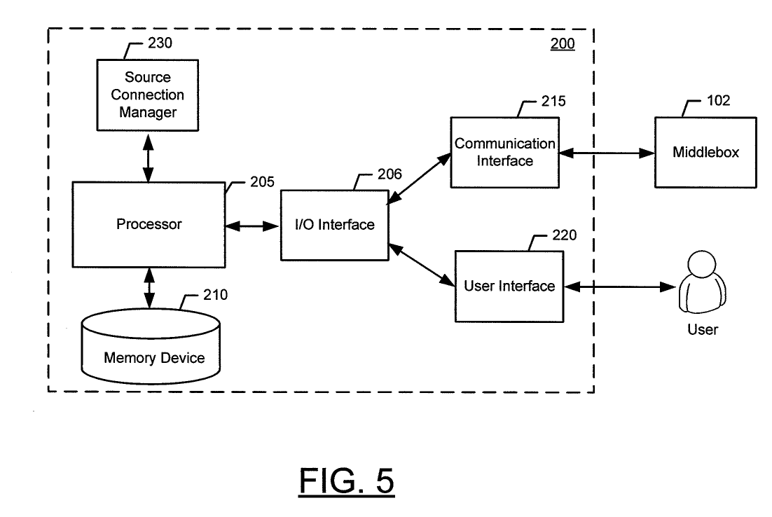

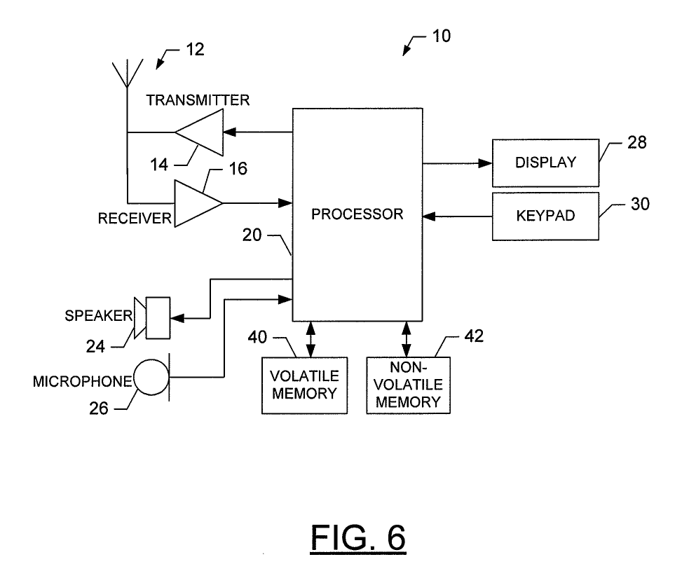

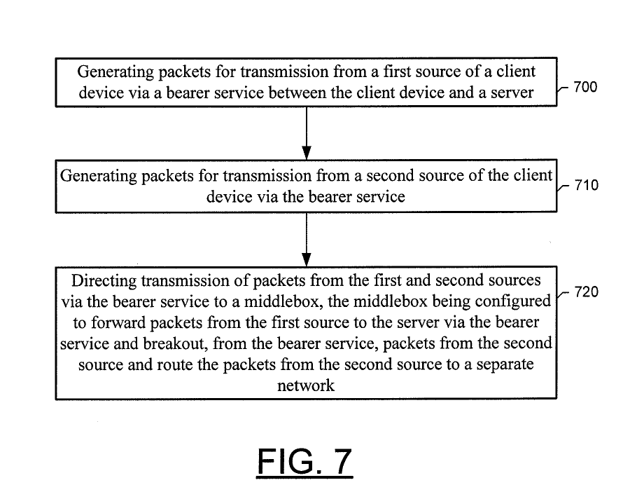

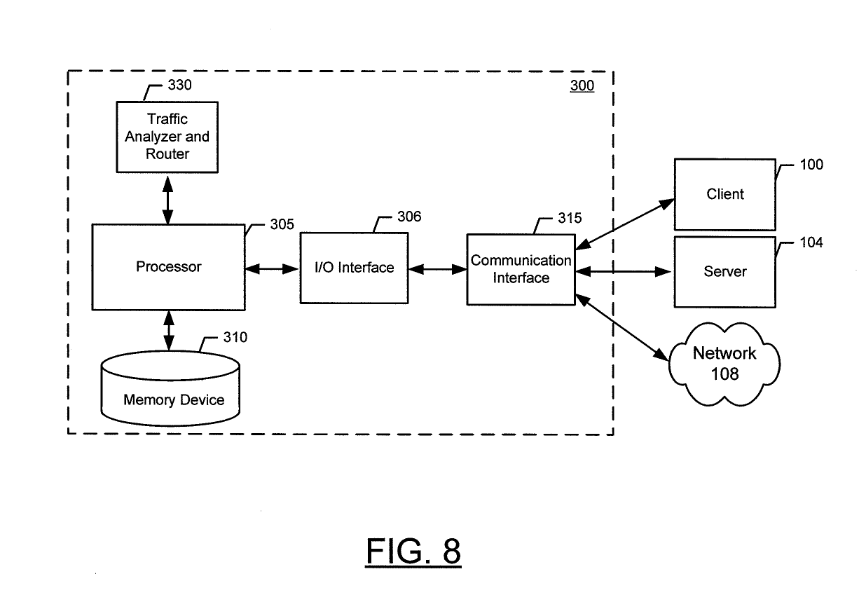

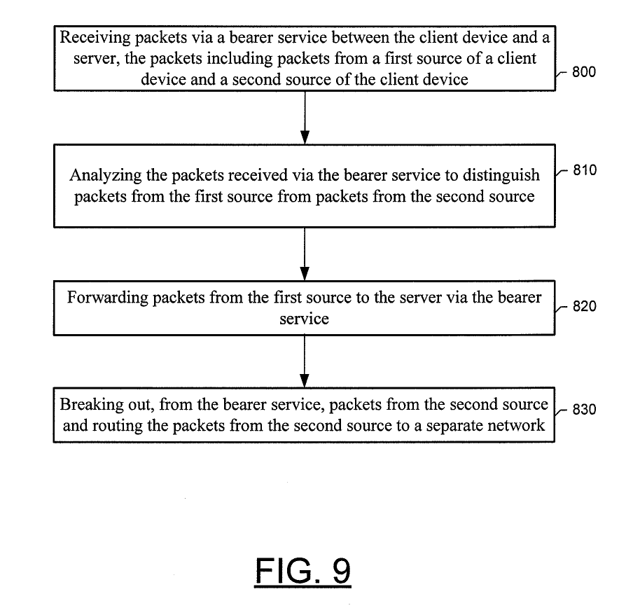

The description provided above and generally herein illustrates example methods, example apparatuses, and example computer program products for communications traffic breakout. FIGS. 5-9 illustrate example apparatus embodiments of the present invention configured to perform the various functionalities described herein. FIGS. 5 and 6 depict example apparatuses that are configured to perform various functionalities from the perspective of a client device (e.g., client 100) as described herein, and FIG. 7 depicts an example method from the perspective of a client device (e.g., client 100) as described herein. FIG. 8 depicts an example apparatus that is configured to perform various functionalities from the perspective of a middlebox (e.g., middlebox 102) as described herein, and FIG. 9 depicts an example method from the perspective of a middlebox (e.g., middlebox 102) as described herein.

Referring now to FIG. 5, in some example embodiments, the apparatus 200 may be embodied as, or may be included as, a component of, a communications device with wired or wireless communications capabilities. In this regard, the apparatus 200 may be configured to operate in accordance with the functionality of a client device as described herein. In some example embodiments, the apparatus 200 may be part of a communications device such as a stationary or a mobile terminal. As a stationary terminal, the apparatus 200 may be part of an access point (e.g., a base station, wireless router, or the like), a computer, a server, a device that supports network communications, or the like. As a mobile terminal, the apparatus 200 may be a mobile computer, mobile telephone, a portable digital assistant (PDA), a pager, a mobile television, a gaming device, a mobile computer, a laptop computer possibly with a wireless modem, a camera, a video recorder, an audio/video player, a radio, and/or a global positioning system (GPS) device, any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, user interface 220, and a source connection manager 230. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to example embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 215 and the user interface 220. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 215 may be any device or means embodied in either hardware, a computer program product, or a combination of hardware and a computer program product that is configured to receive and/or transmit data from/to a network and/or any other device or module in communication with the example apparatus 200. In some example embodiments, the communications interface may be part of, or include, a wireless modem connected to a personal computer. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 220 may be in communication with the processor 205 to receive user input via the user interface 220 and/or to present output to a user as, for example, audible, visual, mechanical or other output indications. The user interface 220 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The source connection manager 230 of example apparatus 200 may be any means or device embodied, partially or wholly, in hardware, a computer program product, or a combination of hardware and a computer program product, such as processor 205 implementing stored instructions to configure the example apparatus 200, memory device 210 storing executable program code instructions configured to carry out the functions described herein, or a hardware configured processor 205 that is configured to carry out the functions of the source connection manager 230 as described herein. In an example embodiment, the processor 205 includes, or controls, the source connection manager 230. The source connection manager 230 may be, partially or wholly, embodied as processors similar to, but separate from processor 205. In this regard, the source connection manager 230 may be in communication with the processor 205. In various example embodiments, the source connection manager 230 may, partially or wholly, reside on differing apparatuses such that some or all of the functionality of the source connection manager 230 may be performed by a first apparatus, and the remainder of the functionality of the source connection manager 230 may be performed by one or more other apparatuses.

The apparatus 200 and the processor 205 may be configured to perform the following functionality via the source connection manager 230. The source connection manager 230 may be configured to perform a number of operations of an example method as depicted in FIG. 7. In this regard, the source connection manager 230 may be configured to generate packets for transmission from a first source of a client device at 700, and generate packets for transmission from a second source of the client at 710. According to some example embodiments, the client device may be the apparatus 200. The packets may be generated for transmission via a bearer service that has been established between the client device and a server. An intermediate device that supports the bearer service may be a middlebox 102. The source connection manager 230 may be further configured to direct transmission of packets from the first and second sources via the bearer service to the middlebox 102 at 720. The middlebox 102 may be configured to forward packets from the first source to a server via the bearer service, and breakout, from the bearer service, packets from the second source and route the packets from the second source to a separate network.

According to some example embodiments, the source connection manager 230 may be configured to generate packets for the first source with a first source protocol address (e.g., first IPv4 address). In this regard, the server connected to the bearer service may be configured to identify packets originating from the client device based on the first source protocol address. The source connection manager 230 may also be configured to generate packets for the second source with a second source protocol address (e.g., second IPv4 address). The second source protocol address may have been assigned to the client device via the middlebox.

According to some example embodiments, the source connection manager 230 may be configured to generate packets for the first source with a first source protocol address (e.g., first IPv6 address). The first source protocol address may have been determined based on an assigned prefix. Further, the server connected to the bearer service may be configured to identify packets originating from the client device based on the first source protocol address. The source connection manager 230 may also be configured to generate packets for the second source with a second source protocol address (e.g., second IPv6 address). The second source protocol address may also have been determined based on the assigned prefix and assigned via the middlebox.

According to some example embodiments, the source connection manager 230 may be configured to generate packets for transmission from the second source of the client device via the bearer service by encapsulating packets of a first protocol into packets of a second protocol. The generation of packets for the second source may also include generating the packets with a selected source address for indicating that the packets for transmission from the second source are intended for the separate network. Further, source connection manager 230 may be configured to direct transmission of the packets from the second source by directing establishment of a tunnel based on the second protocol from the client device to the middlebox 102 within the bearer service (e.g., an Ethernet over IP tunnel).

According to some example embodiments, the source connection manager 230 may be configured to generate packets for transmission from the first source by generating packets based on a first protocol, and configured to generate packets for transmission from the second source by generating packets based on a second protocol. In some example embodiments, the packets generated based on the first protocol may be Internet Protocol (IP) packets and that packets generated based on the second protocol may be Ethernet packets.

Referring now to FIG. 6, a more specific example apparatus in accordance with various embodiments of the present invention is provided. The example apparatus of FIG. 6 is a mobile terminal 10 configured to communicate within a wireless network, such as a cellular communications network. The mobile terminal 10 may be configured to perform the functionality of the client device and/or apparatus 200 as described herein. More specifically, the mobile terminal 10 may be caused to perform the functionality of the source connection manager 230 and/or the operations of FIG. 7 via the processor 20. In this regard, processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface.

Referring now to FIG. 8, in some example embodiments, the apparatus 300 may be embodied as, or may be included as, a component of, a communications device with wired or wireless communications capabilities. In this regard, the apparatus 300 may be configured to operate in accordance with the functionality of the middlebox 102 as described herein. In some example embodiments, the apparatus 300 may be part of a communications device such as a stationary or a mobile terminal. As a stationary terminal, the apparatus 300 may be part of an access point (e.g., a base station, wireless router, or the like), a computer, a server, a device that supports network communications, or the like. As a mobile terminal, the apparatus 300 may be a mobile computer, mobile telephone, a portable digital assistant (PDA), a pager, a mobile television, a gaming device, a mobile computer, a laptop computer possibly with a wireless modem, a camera, a video recorder, an audio/video player, a radio, and/or a global positioning system (GPS) device, any combination of the aforementioned, or the like. Regardless of the type of communications device, apparatus 300 may also include computing capabilities.

The example apparatus 300 includes or is otherwise in communication with a processor 305, a memory device 310, an Input/Output (I/O) interface 306, a communications interface 315, and a traffic analyzer and router 330. The processor 305 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 305 may be representative of a plurality of processors, or one or more multiple core processors, operating in concert. Further, the processor 305 may be comprised of a plurality of transistors, logic gates, a clock (e.g., oscillator), other circuitry, and the like to facilitate performance of the functionality described herein. The processor 305 may, but need not, include one or more accompanying digital signal processors. In some example embodiments, the processor 305 is configured to execute instructions stored in the memory device 310 or instructions otherwise accessible to the processor 305. The processor 305 may be configured to operate such that the processor causes the apparatus 300 to perform various functionalities described herein.

Whether configured as hardware or via instructions stored on a computer-readable storage medium, or by a combination thereof, the processor 305 may be an entity capable of performing operations according to example embodiments of the present invention while configured accordingly. Thus, in example embodiments where the processor 305 is embodied as, or is part of, an ASIC, FPGA, or the like, the processor 305 is specifically configured hardware for conducting the operations described herein. Alternatively, in example embodiments where the processor 305 is embodied as an executor of instructions stored on a computer-readable storage medium, the instructions specifically configure the processor 305 to perform the algorithms and operations described herein. In some example embodiments, the processor 305 is a processor of a specific device (e.g., a mobile terminal) configured for employing example embodiments of the present invention by further configuration of the processor 305 via executed instructions for performing the algorithms, methods, and operations described herein.

The memory device 310 may be one or more computer-readable storage media that may include volatile and/or non-volatile memory. In some example embodiments, the memory device 310 includes Random Access Memory (RAM) including dynamic and/or static RAM, on-chip or off-chip cache memory, and/or the like. Further, memory device 310 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 310 may include a cache area for temporary storage of data. In this regard, some or all of memory device 310 may be included within the processor 305.

Further, the memory device 310 may be configured to store information, data, applications, computer-readable program code instructions, and/or the like for enabling the processor 305 and the example apparatus 300 to carry out various functions in accordance with example embodiments of the present invention described herein. For example, the memory device 310 could be configured to buffer input data for processing by the processor 305. Additionally, or alternatively, the memory device 310 may be configured to store instructions for execution by the processor 305.

The I/O interface 306 may be any device, circuitry, or means embodied in hardware, software, or a combination of hardware and software that is configured to interface the processor 305 with other circuitry or devices, such as the communications interface 315. In some example embodiments, the processor 305 may interface with the memory 310 via the I/O interface 306. The I/O interface 306 may be configured to convert signals and data into a form that may be interpreted by the processor 305. The I/O interface 306 may also perform buffering of inputs and outputs to support the operation of the processor 305. According to some example embodiments, the processor 305 and the I/O interface 306 may be combined onto a single chip or integrated circuit configured to perform, or cause the apparatus 300 to perform, various functionalities of the present invention.

The communication interface 315 may be any device or means embodied in either hardware, a computer program product, or a combination of hardware and a computer program product that is configured to receive and/or transmit data from/to a network and/or any other device or module in communication with the example apparatus 300. Processor 305 may also be configured to facilitate communications via the communications interface by, for example, controlling hardware included within the communications interface 315. In this regard, the communication interface 315 may include, for example, one or more antennas, a transmitter, a receiver, a transceiver and/or supporting hardware, including, for example, a processor for enabling communications. Via the communication interface 315, the example apparatus 300 may communicate with various other network entities in a device-to-device fashion and/or via indirect communications via a base station, access point, server, gateway, router, or the like.

The communications interface 315 may be configured to provide for communications in accordance with any wired or wireless communication standard. In some example embodiments, the communications interface 315 is configured to support wired communications protocols such as IEEE 802.3, or the like. The communications interface 315 may be configured to support communications in multiple antenna environments, such as multiple input multiple output (MIMO) environments. Further, the communications interface 315 may be configured to support orthogonal frequency division multiplexed (OFDM) signaling. In some example embodiments, the communications interface 315 may be configured to communicate in accordance with various techniques, such as, second-generation (3G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA3000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 315 may be configured to provide for communications in accordance with techniques such as, for example, radio frequency (RF), infrared (IrDA) or any of a number of different wireless networking techniques, including WLAN techniques such as IEEE 803.11 (e.g., 803.11a, 803.11b, 803.11g, 803.11n, etc.), wireless local area network (WLAN) protocols, world interoperability for microwave access (WiMAX) techniques such as IEEE 803.16, and/or wireless Personal Area Network (WPAN) techniques such as IEEE 803.15, BlueTooth (BT), low power versions of BT, ultra wideband (UWB), Wibree, Zigbee and/or the like. The communications interface 315 may also be configured to support communications at the network layer, possibly via Internet Protocol (IP).

The traffic analyzer and router 330 of example apparatus 300 may be any means or device embodied, partially or wholly, in hardware, a computer program product, or a combination of hardware and a computer program product, such as processor 305 implementing stored instructions to configure the example apparatus 300, memory device 310 storing executable program code instructions configured to carry out the functions described herein, or a hardware configured processor 305 that is configured to carry out the functions of the traffic analyzer and router 330 as described herein. In an example embodiment, the processor 305 includes, or controls, the traffic analyzer and router 330. The traffic analyzer and router 330 may be, partially or wholly, embodied as processors similar to, but separate from processor 305. In this regard, the traffic analyzer and router 330 may be in communication with the processor 305. In various example embodiments, the traffic analyzer and router 330 may, partially or wholly, reside on differing apparatuses such that some or all of the functionality of the traffic analyzer and router 330 may be performed by a first apparatus, and the remainder of the functionality of the traffic analyzer and router 330 may be performed by one or more other apparatuses.

The apparatus 300 and the processor 305 may be configured to perform the following functionality via the traffic analyzer and router 330. The traffic analyzer and router 330 may be configured to perform a number of operations of an example method as depicted in FIG. 9. In this regard, the traffic analyzer and router 330 may be configured to receive packets via a bearer service between a client device and a server at 800. The received packets may include packets from a first source of the client device and a second source of the client device. The traffic analyzer and router 330 may be further configured to analyze the packets received via the bearer service to distinguish packets from the first source from packets from the second source at 810. Additionally, the traffic analyzer and router 330 may be configured to forward packets from the first source of the client device to the server via the bearer service at 820. The traffic analyzer and router 330 may also be configured to break out, from the bearer service, packets from the second source, and route the packets from the second source to a separate network at 830.

According to some example embodiments, the traffic analyzer and router 330 may be configured to analyze the packets received via the bearer service to distinguish packets from the first source from packets from the second source by analyzing a source address of the packets received via the bearer service to determine that packets with a first source protocol address (e.g., IPv4 address) are from the first source and packets with a second source protocol address (e.g., IPv4 address) are packets from the second source. In this regard, the server may be configured to identify packets originating from the client device based on the first source protocol address. The second source protocol address may have been assigned to the client device via a middlebox, such as the apparatus 300.

According to some example embodiments, the traffic analyzer and router 330 may be configured to analyze the packets received via the bearer service to distinguish packets from the first source from packets from the second source by analyzing a source address of the packets received via the bearer service to determine that packets with a first source protocol address (e.g., IPv6 address) are from the first source and packets with a second source protocol address (e.g., IPv6 address) are from the second source. In this regard, the first source protocol address and the second source protocol address may have been determined based on an assigned prefix. The server may be configured to identify packets originating from the client device based on the first source protocol address. The second source protocol address may have been assigned via a middlebox, such as the apparatus 300.

According to some example embodiments, the traffic analyzer and router 330 may also be configured to analyze the packets received via the bearer service to distinguish packets from the first source from packets from the second source by analyzing the packets received via the bearer service to determine that packets of a first protocol are encapsulated in a second protocol having a predetermined source address are packets from the second source. The packets from the second source may have been received via a tunnel (e.g., an Ethernet over IP tunnel) within the bearer service between the client device and a middlebox based on the second protocol.

According to some example embodiments, the traffic analyzer and router 330 may be further configured to analyze the packets received via the bearer service to distinguish packets from the first source from packets from the second source by analyzing the packets received via the bearer service to determine that packets of a first protocol are packets from the first source and packets of a second protocol are packets from the second source. In this regard, for example, packets of the first protocol associated with the first source may be internet protocol (IP) packets, and packets of the second protocol associated with the second source may be Ethernet packets.

FIGS. 7 and 9 illustrate flowcharts of example systems, methods, and/or computer program products according to example embodiments of the invention. It will be understood that each operation of the flowcharts, and/or combinations operations in the flowcharts, can be implemented by various means. Means for implementing the operations of the flowcharts, combinations operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions may be stored on a memory device, such as memory device 210 or memory device 310, of an example apparatus, such as example apparatus 200 or example apparatus 300, and executed by a processor, such as the processors 205 and 305. As will be appreciated, any such program code instructions may be loaded onto a computer or other programmable apparatus (e.g., processor 205 or 305, memory device 210 or 310, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the operations of the flowcharts in a computer-readable storage medium, support combinations of operations for performing the specified functions. It will also be understood that one or more operations of the flowcharts, and combinations of operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
generating packets for transmission from a first source of a client device via a bearer service between the client device and a server;
generating packets for transmission from a second source of the client device via the bearer service; and
directing, via a processor, transmission of packets from the first and second sources via the bearer service to a middlebox, the middlebox being configured to forward packets from the first source to the server via the bearer service and breakout, from the bearer service, packets from the second source and route the packets from the second source to a separate network.

2. The method of claim 1, wherein generating packets for transmission from the first source includes generating packets with a first source protocol address, the server being configured to identify packets originating from the client device based on the first source protocol address; and wherein generating packets for transmission from the second source includes generating packets with a second source protocol address, the second source protocol address having been assigned via the middlebox.

3. The method of claim 1, wherein generating packets for transmission from the first source includes generating packets with a first source protocol address, the first source protocol address having been determined based on an assigned prefix, the server being configured to identify packets originating from the client device based on the first source protocol address; and wherein generating packets for transmission from the second source includes generating packets with a second source protocol address, the second source protocol address also having been determined based on the assigned prefix and assigned via the middlebox.

4. The method of claim 1, wherein generating packets for transmission from the second source of the client device via the bearer service, includes encapsulating packets of a first protocol into packets of a second protocol and generating the packets for transmission from the second source with a selected source address for indicating that the packets for transmission from the second source are intended for the separate network; and wherein directing transmission of the packets from the second source includes directing establishment of a tunnel based on the second protocol from the client device to the middlebox within the bearer service.

5. The method of claim 1, wherein generating packets for transmission from the first source includes generating packets based on a first protocol; and wherein generating packets for transmission from the second source includes generating packets based on a second protocol.

6. An apparatus comprising at least one processor and at least one memory including computer program code, the at least one memory and the computer program code configured to, with the at least one processor, cause the apparatus at least to perform:
generating packets for transmission from a first source of a client device via a bearer service between the client device and a server;
generating packets for transmission from a second source of the client device via the bearer service; and
directing transmission of packets from the first and second sources via the bearer service to a middlebox, the middlebox being configured to forward packets from the first source to the server via the bearer service and breakout, from the bearer service, packets from the second source and route the packets from the second source to a separate network.

7. The apparatus of claim 6, wherein the apparatus caused to perform generating packets for transmission from the first source includes being caused to perform generating packets with a first source protocol address, the server being configured to identify packets originating from the client device based on the first source protocol address; and wherein the apparatus caused to perform generating packets for transmission from the second source includes being caused to perform generating packets with a second source protocol address, the second source protocol address having been assigned via the middlebox.

8. The apparatus of claim 6, wherein the apparatus caused to perform generating packets for transmission from the first source includes being caused to perform generating packets with a first source protocol address, the first source protocol address having been determined based on an assigned prefix, the server being configured to identify packets originating from the client device based on the first source protocol address; and wherein the apparatus caused to perform generating packets for transmission from the second source includes being caused to perform generating packets with a second source protocol address, the second source protocol address also having been determined based on the assigned prefix and assigned via the middlebox.

9. The apparatus of claim 6, wherein the apparatus caused to perform generating packets for transmission from the second source of the client device via the bearer service, includes being caused to perform encapsulating packets of a first protocol into packets of a second protocol and generating the packets for transmission from the second source with a selected source address for indicating that the packets for transmission from the second source are intended for the separate network; and wherein the apparatus caused to perform directing transmission of the packets from the second source includes being caused to perform directing establishment of a tunnel based on the second protocol from the client device to the middlebox within the bearer service.

10. The apparatus of claim 6, wherein the apparatus caused to perform generating packets for transmission from the first source includes being caused to perform generating packets based on a first protocol; and wherein the apparatus caused to perform generating packets for transmission from the second source includes being caused to perform generating packets based on a second protocol.

11. The apparatus of claim 6, wherein the apparatus caused to perform generating packets for transmission from the first source includes being caused to perform generating packets Internet Protocol (IP) packets; and wherein the apparatus caused to perform generating packets for transmission from the second source includes being caused to perform generating Ethernet packets.

12. A method comprising:
receiving packets via a bearer service between a client device and a server, the packets including packets from a first source of the client device and a second source of the client device;
analyzing, via a processor, the packets received via the bearer service to distinguish packets from the first source from packets from the second source;
forwarding packets from the first source to the server via the bearer service; and
breaking out, from the bearer service, packets from the second source and routing the packets from the second source to a separate network.

13. The method of claim 12, wherein analyzing the packets received via the bearer service to distinguish packets from the first source from packets from the second source includes analyzing a source address of the packets received via the bearer service to determine that packets with a first source protocol address are from the first source and packets with a second source protocol address are packets from the second source, the server being configured to identify packets originating from the client device based on the first source protocol address, and the second source protocol address having been assigned via a middlebox.

14. The method of claim 12, wherein analyzing the packets received via the bearer service to distinguish packets from the first source from packets from the second source includes analyzing a source address of the packets received via the bearer service to determine that packets with a first source protocol address are from the first source and packets with a second source protocol address are from the second source, the first source protocol address and the second source protocol address having been determined based on an assigned prefix, the server being configured to identify packets originating from the client device based on the first source protocol address, and the second source protocol address having been assigned via a middlebox.

15. The method of claim 12, wherein analyzing the packets received via the bearer service to distinguish packets from the first source from packets from the second source includes analyzing the packets received via the bearer service to determine that packets of a first protocol encapsulated in a second protocol having a predetermined source address are packets from the second source, the packets from the second source having been received via a tunnel within the bearer service between the client device and a middlebox based on the second protocol.

16. The method of claim 12, wherein analyzing the packets received via the bearer service to distinguish packets from the first source from packets from the second source includes analyzing the packets received via the bearer service to determine that packets of a first protocol are packets from the first source and packets of a second protocol are packets from the second source.

17. An apparatus comprising at least one processor and at least one memory including computer program code, the at least one memory and the computer program code configured to, with the at least one processor, cause the apparatus at least to perform:
receiving packets via a bearer service between a client device and a server, the packets including packets from a first source of the client device and a second source of the client device;
analyzing the packets received via the bearer service to distinguish packets from the first source from packets from the second source;
forwarding packets from the first source to the server via the bearer service; and
breaking out, from the bearer service, packets from the second source and routing the packets from the second source to a separate network.

18. The apparatus of claim 17, wherein the apparatus caused to perform analyzing the packets received via the bearer service to distinguish packets from the first source from packets from the second source includes being caused to perform analyzing a source address of the packets received via the bearer service to determine that packets with a first source protocol address are from the first source and packets with a second source protocol address are packets from the second source, the server being configured to identify packets originating from the client device based on the first source protocol address, and the second source protocol address having been assigned via a middlebox.

19. The apparatus of claim 17, wherein the apparatus caused to perform analyzing the packets received via the bearer service to distinguish packets from the first source from packets from the second source includes being caused to perform analyzing a source address of the packets received via the bearer service to determine that packets with a first source protocol address are from the first source and packets with a second source protocol address are from the second source, the first source protocol address and the second source protocol address having been determined based on an assigned prefix, the server being configured to identify packets originating from the client device based on the first source protocol address, and the second source protocol address having been assigned via a middlebox.

20. The apparatus of claim 17, wherein the apparatus caused to perform analyzing the packets received via the bearer service to distinguish packets from the first source from packets from the second source includes being caused to perform analyzing the packets received via the bearer service to determine that packets of a first protocol encapsulated in a second protocol having a predetermined source address are packets from the second source, the packets from the second source having been received via a tunnel within the bearer service between the client device and a middlebox based on the second protocol.

21. The apparatus of claim 17, wherein the apparatus caused to perform analyzing the packets received via the bearer service to distinguish packets from the first source from packets from the second source includes being caused to perform analyzing the packets received via the bearer service to determine that packets of a first protocol are packets from the first source and packets of a second protocol are packets from the second source.

22. The apparatus of claim 17, wherein the apparatus caused to perform analyzing the packets received via the bearer service to distinguish packets from the first source from packets from the second source includes being caused to perform analyzing the packets received via the bearer service to determine that internet protocol (IP) packets are packets from the first source and Ethernet packets are packets from the second source.

23. A computer-readable storage medium having executable computer-readable program code instructions stored therein, the instructions being configured to cause an apparatus to perform:
receiving packets via a bearer service between a client device and a server, the packets including packets from a first source of the client device and a second source of the client device;
analyzing, via a processor, the packets received via the bearer service to distinguish packets from the first source from packets from the second source;
forwarding packets from the first source to the server via the bearer service; and
breaking out, from the bearer service, packets from the second source and routing the packets from the second source to a separate network.

24. The computer-readable storage medium of claim 23, wherein the instructions configured to cause the apparatus to perform analyzing the packets received via the bearer service to distinguish packets from the first source from packets from the second source include instructions configured to cause the apparatus to perform analyzing a source address of the packets received via the bearer service to determine that packets with a first source protocol address are from the first source and packets with a second source protocol address are packets from the second source, the server being configured to identify packets originating from the client device based on the first source protocol address, and the second source protocol address having been assigned via a middlebox.

25. The computer-readable storage medium of claim 23, wherein the instructions configured to cause the apparatus to perform analyzing the packets received via the bearer service to distinguish packets from the first source from packets from the second source include instructions configured to cause the apparatus to perform analyzing a source address of the packets received via the bearer service to determine that packets with a first source protocol address are from the first source and packets with a second source protocol address are from the second source, the first source protocol address and the second source protocol address having been determined based on an assigned prefix, the server being configured to identify packets originating from the client device based on the first source protocol address, and the second source protocol address having been assigned via a middlebox.

26. The computer-readable storage medium of claim 23, wherein the instructions configured to cause the apparatus to perform analyzing the packets received via the bearer service to distinguish packets from the first source from packets from the second source include instructions configured to cause the apparatus to perform analyzing the packets received via the bearer service to determine that packets of a first protocol encapsulated in a second protocol having a predetermined source address are packets from the second source, the packets from the second source having been received via a tunnel within the bearer service between the client device and a middlebox based on the second protocol.

27. The computer-readable storage medium of claim 23, wherein the instructions configured to cause the apparatus to perform analyzing the packets received via the bearer service to distinguish packets from the first source from packets from the second source include instructions configured to cause the apparatus to perform analyzing the packets received via the bearer service to determine that packets of a first protocol are packets from the first source and packets of a second protocol are packets from the second source.
